(19) United States
(12) Patent Application Publication
(10) Pub. No.: US 2025/0388029 A1
(43) Pub. Date: Dec. 25, 2025

(54) IMAGE PROCESSING APPARATUS AND INFORMATION PROCESSING METHOD

(71) Applicant: TOSHIBA TEC KABUSHIKI KAISHA, Tokyo (JP)

(72) Inventor: Takanori Fukuhara, Mishima Shizuoka (JP)

(21) Appl. No.: 18/895,833

(22) Filed: Sep. 25, 2024

(30) Foreign Application Priority Data
Jun. 20, 2024 (JP) 2024-099940

(51) Int. Cl. B41J 2/365; B41J 2/355

(52) U.S. Cl. CPC B41J 2/365; B41J 2/3555

(57) ABSTRACT

According to one embodiment, an image processing apparatus includes a reading unit, a detection unit, a determination unit, and a processing unit. The reading unit reads an image printed based on predetermined test image data by a thermal printer that performs thermal control according to a thermal history table. The detection unit detects a difference between the image read by the reading unit and a test image represented by the test image data. The determination unit determines a thermal history table for compensating for the difference detected by the detection unit. The processing unit performs a predetermined process for setting the thermal history table determined by the determination unit in the thermal printer.

### CROSS-REFERENCE TO RELATED APPLICATION

This application is based upon and claims the benefit of priority from Japanese Patent Application No. 2024-099940, filed on Jun. 20, 2024, the entire contents of which are incorporated herein by reference.

### FIELD

Embodiments described herein relate generally to an image processing apparatus and an information processing method.

### BACKGROUND

After a heating element in a thermal printer is energized under certain energization conditions, a temperature of the heating element changes depending on previous energization conditions and environmental conditions.

As such, thermal control is traditionally performed using a thermal history table that is determined in advance and takes into account various conditions to compensate for such temperature changes.

However, when the predetermined thermal history table is not appropriate for actual usage conditions of the thermal printer, there is a risk that thermal control will not be performed properly. For example, various types of printing paper can be used as appropriate, and differences in the type of paper can affect thermal control.

For these reasons, it is desirable to be able to perform appropriate thermal control in thermal printers according to the actual usage conditions.

### DESCRIPTION OF THE DRAWINGS

FIG. 1 is a block diagram illustrating a general configuration of a printer management system according to an embodiment;

FIG. 2 is a block diagram illustrating an example of a main circuit configuration of a multifunction device in FIG. 1;

FIG. 3 is a block diagram illustrating an example of a main circuit configuration of a label printer in FIG. 1; and

FIG. 4 is a flowchart illustrating a processing procedure of a processor in the multifunction device during management processing and a processing procedure of a processor in the label printer associated with the management processing.

### DETAILED DESCRIPTION

An aspect of an exemplary embodiment is to provide an image processing apparatus and an information processing method that are capable of appropriately performing heat control in a thermal printer according to an actual usage condition.

In general, according to one embodiment, an image processing apparatus includes a reading unit, a detection unit, a determination unit, and a processing unit. The reading unit reads an image printed based on predetermined test image data by a thermal printer that performs thermal control according to a thermal history table. The detection unit detects a difference between the image read by the reading unit and a test image represented by the test image data. The determination unit determines a thermal history table for compensating for the difference detected by the detection unit. The processing unit performs a predetermined process for setting the thermal history table determined by the determination unit in the thermal printer.

An example of an embodiment will be described below with reference to the drawings.

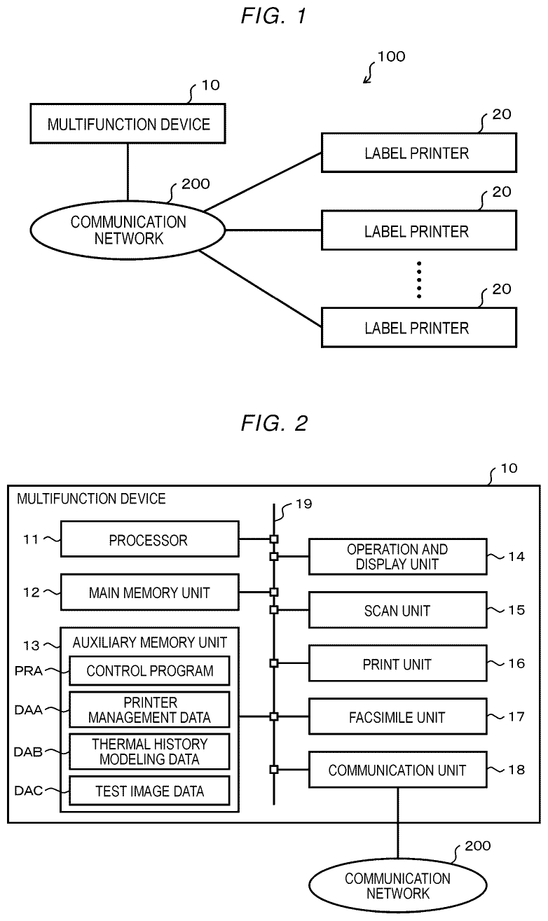

FIG. 1 is a block diagram illustrating a general configuration of a printer management system 100 according to this embodiment.

The printer management system 100 is configured to enable communication between a multifunction device 10 and a plurality of label printers 20 via a communication network 200. The printer management system 100 may include any number of label printers 20, and may include only one.

This printer management system 100 is envisioned for use in a store such as a supermarket. As an example, the multifunction device 10 is installed in a store's office, and the label printer 20 is installed in a store's back yard. The printer management system 100 then uses the multifunction device 10 to perform management processing for maintaining a print quality of the label printer 20. In this case, a local area network (LAN) constructed in the store is used as the communication network 200. In addition to LAN, the Internet, a virtual private network (VPN), a local area network (LAN), a public communication network, a mobile communication network, and the like can be used as the communication network, either alone or in appropriate combination.

The multifunction device 10 provides a plurality of functions to a user. In this embodiment, the multifunction device 10 provides various functions similar to those provided by existing multifunction devices, such as a scan function, a print function, a facsimile function, or a copy function. The functions that the multifunction device 10 can provide may be a part of the various functions described above, or may include other functions such as an image file management function. However, the multifunction device 10 has at least a scan function. The multifunction device 10 also has a function described below for managing the label printers 20 that are pre-registered as management targets.

The label printer 20 prints any image onto a label paper sheet on which a plurality of labels are arranged on a mount sheet. The image printed by the label printer 20 is typically a label image showing a product name, a sales price, and the like.

FIG. 2 is a block diagram illustrating an example of a main circuit configuration of the multifunction device 10.

The multifunction device 10 includes a processor 11, a main memory unit 12, an auxiliary memory unit 13, an operation and display unit 14, a scan unit 15, a print unit 16, a facsimile unit 17, a communication unit 18, and a transmission path 19.

The processor 11, the main memory unit 12, and the auxiliary memory unit 13 are connected via the transmission path 19 to form a computer that performs information processing for controlling the multifunction device 10.

The processor 11 corresponds to a central part of the computer. The processor 11 executes information processing to control each part to realize various functions of the multifunction device 10 in accordance with information processing programs such as an operating system and application programs.

The main memory unit 12 corresponds to a main memory portion of the computer. The main memory unit 12 includes a read-only memory area and a rewritable memory area. The main memory unit 12 stores part of the information processing program in the read-only memory area. The main memory unit 12 may also store data necessary for the processor 11 to execute processes to control each part in the read-only memory area or the rewritable memory area. The main memory unit 12 uses the rewritable memory area as a work area by the processor 11.

The auxiliary memory unit 13 corresponds to an auxiliary memory portion of the computer. The auxiliary memory unit 13 may be, for example, an electrical erasable programmable read-only memory (EEPROM), a hard disk drive (HDD), a solid state drive (SSD), or any other known memory device. The auxiliary memory unit 13 stores data used by the processor 11 in performing various processes and data generated by the processes in the processor 11. The auxiliary memory unit 13 may also store the information processing program. In this embodiment, the auxiliary memory unit 13 stores a control program PRA, which is one of the information processing programs. The control program PRA represents a procedure of a control process for appropriately realizing various functions in response to a user's request. A part of the memory area of the auxiliary memory unit 13 is used as an area for storing printer management data DAA, thermal history modeling data DAB, and test image data DAC. The printer management data DAA, the thermal history modeling data DAB, and the test image data DAC will be described below.

The operation and display unit 14 inputs various instructions from an operator and displays various information to the operator. The operation and display unit 14 may include various operation devices and display devices such as a touch panel, a keyboard, a key switch, an LED (light emitting diode) lamp, or a liquid crystal display panel, as appropriate. In most cases, the operator is a user of the multifunction device 10. However, there are also cases where the operator is a worker who performs maintenance on the multifunction device 10.

The scan unit 15 reads an original document and generates image data of the image represented on the original document.

The print unit 16 prints an image represented by the image data onto an appropriate printing paper sheet. The print unit 16 includes a well-known print device, such as an electrophotographic image forming device.

The facsimile unit 17 performs various well-known processes for performing image communication conforming to facsimile standards via a communication network (not illustrated) such as a public switched telephone network (PSTN).

The communication unit 18 executes communication processing for transmitting and receiving data via the communication network 200. As the communication unit 18, for example, an existing communication device that complies with the communication method adopted in the communication network 200 can be used.

The transmission path 19 includes an address bus, a data bus, and control signal lines, and transmits data and control signals exchanged between the connected components.

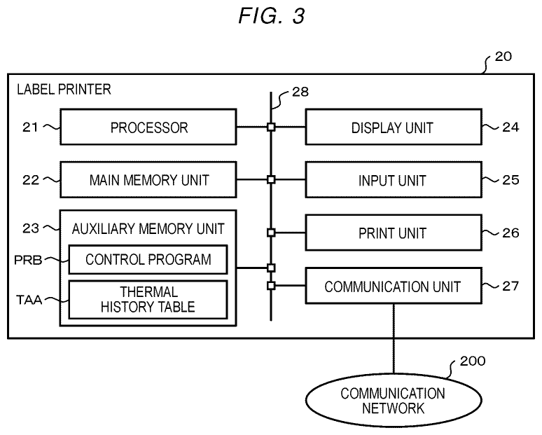

FIG. 3 is a block diagram illustrating an example of a main circuit configuration of the label printer 20.

The label printer 20 includes a processor 21, a main memory unit 22, an auxiliary memory unit 23, a display unit 24, an input unit 25, a print unit 26, a communication unit 27, and a transmission path 28.

The processor 21, the main memory unit 22, and the auxiliary memory unit 23 are connected via the transmission path 28 to form a computer that performs information processing for controlling the label printer 20.

The processor 21 corresponds to a central part of the computer. The processor 21 executes information processing to control each part to realize various functions of the label printer 20 in accordance with information processing programs such as an operating system and application programs.

The main memory unit 22 corresponds to a main memory portion of the computer. The main memory unit 22 includes a read-only memory area and a rewritable memory area. The main memory unit 22 stores part of the information processing program in the read-only memory area. The main memory unit 22 may also store data necessary for the processor 21 to execute processes for controlling each part in the read-only memory area or the rewritable memory area. The main memory unit 22 uses the rewritable memory area as a work area by the processor 21.

The auxiliary memory unit 23 corresponds to an auxiliary memory portion of the computer. The auxiliary memory unit 23 is, for example, an electrically erasable programmable read-only memory (EEPROM). The auxiliary memory unit 23 may be a hard disk drive (HDD), a solid state drive (SSD), or any other well-known memory device. The auxiliary memory unit 23 stores data used by the processor 21 in performing various processes and data generated by the processes in the processor 21. The auxiliary memory unit 23 may also store the information processing program. In this embodiment, the auxiliary memory unit 23 stores a control program PRB, which is one of the information processing programs. The control program PRB represents a procedure of a control process for realizing various functions of the label printer 20. A part of a storage area of the auxiliary memory unit 23 is used as an area for storing a thermal history table TAA. Thus, the auxiliary memory unit 23 is an example of a memory unit that stores the thermal history table TAA. The thermal history table TAA will be described below.

The display unit 24 performs various display operations to notify an operator of various types of information. As the display unit 24, well-known display devices such as a screen display device such as a liquid crystal display and a light-emitting device such as an LED lamp can be used alone or in combination. The display device included in the display unit 24 is, for example, a display device provided on a touch panel.

The input unit 25 inputs various instructions from the operator. The input unit 25 may be any well-known input device, such as a touch sensor, a key switch, or a keyboard, either alone or in combination. An input device included in the input unit 25 is, for example, a touch sensor provided on the above-described touch panel.

While transporting a long, narrow mount sheet, the print unit 26 prints a label image, such as characters, on a label paper sheet affixed to one side of the mount sheet. The mount sheet and label paper sheet are typically made of paper, but may be made of materials other than paper, such as resin. The mount sheet and label paper sheet may also be made of different materials. The print unit 26 may be, for example, a thermal transfer printer. That is, the print unit 26 uses a thermal head with a large number of heating elements arranged therein, and forms dots by melting and transferring ink from an ink ribbon to the label paper sheet using the heat from the heating elements, and forms an image using the arrangement of these dots. The print unit 26 may also be a thermosensitive printer.

The communication unit 27 executes communication processing for transmitting and receiving data via the communication network 200. As the communication unit 27, for example, an existing communication device that complies with the communication method adopted in the communication network 200 can be used.

The transmission path 28 includes an address bus, a data bus, and control signal lines, and transmits data and control signals exchanged between the connected components.

Next, an operation of the printer management system 100 configured as described above will be described.

As described above, the print unit 26 prints images by using the heat generated by the heating elements. As a result, printing is affected by heat accumulated due to an operating status of nearby heating elements or a past operating status of the same heating element. Therefore, the print unit 26 performs thermal control to adjust the temperature of the heating elements when forming dots, for example by controlling the time for energizing the heating elements. In other words, the print unit 26 is an example of a printing unit.

This thermal control is a process of adjusting the time for energizing a heating element when forming one dot with the single heating element by referring to the thermal history table TAA. The thermal history table TAA is a data table that defines the time for energizing a heating element when forming one dot with a single heating element, with respect to the past energization history of the heating element, a new energization status of each of a plurality of heating elements predetermined as reference elements, and a plurality of energization patterns each having a different past energization history. The appropriate energization time for forming a required dot changes depending on printing conditions. The printing conditions are, for example, the printing speed, outside temperature, humidity, head element temperature, paper sheet type, and ribbon type. However, the printing conditions may not include some of these elements, or may include other elements. The form of the thermal history table TAA may be the same as that already used in existing thermal printers. In other words, the processing for thermal control in the label printer 20 may be the same as the existing processing.

In the printer management system 100, the multifunction device 10 performs processing for optimizing the thermal history table TAA used in the label printer 20 that is a management target.

The label printers 20 as a management target by the multifunction device 10 are registered in advance in the multifunction device 10. That is, the printer management data DAA showing a list of the label printers 20 as a management target is generated and stored in the auxiliary memory unit 13. The printer management data DAA may be generated by the processor 11 in response to an operation on the operation and display unit 14, or by another information processing device. The printer management data DAA includes at least a communication address for communication via the communication network 200, for example. The printer management data DAA may include any information other than the communication address. In this embodiment, the printer management data DAA includes an identification name for a user to identify each of the plurality of label printers 20, in association with the communication address for that label printer 20.

It is not necessary to set all label printers 20 connected to the communication network 200 as management targets. The printer management data DAA may include information about label printers 20 that are not the management target. In this case, however, information such as a flag is associated with each label printer 20 and included in the printer management data DAA so that it is possible to determine whether a label printer 20 is a management target.

When a user or administrator of the label printer 20 confirms that there is a deterioration in print results on the label printer 20 serving as the management target and determines that this needs to be resolved, he or she instructs the start of the management function of the label printer 20, for example by a predetermined operation on the operation and display unit 14 of the multifunction device 10. In response to this instruction, the processor 11 in the multifunction device 10 starts management processing within the control processing based on the control program PRA. The person who issues these instructions and performs various tasks related to the management functions described below is referred to as a worker.

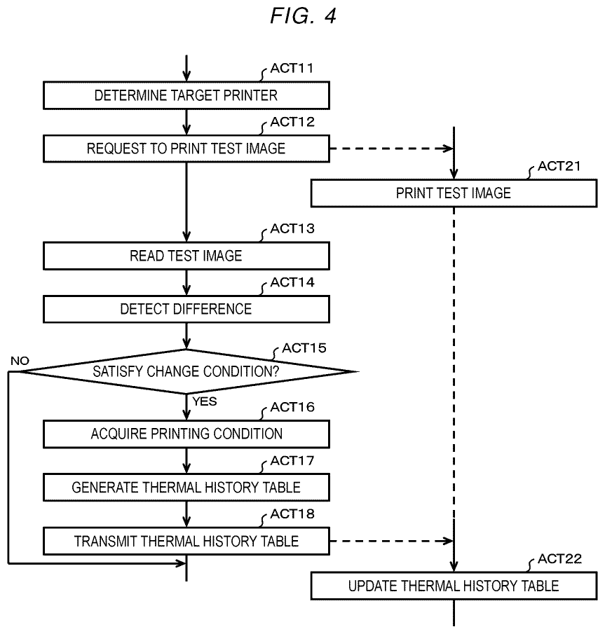

FIG. 4 is a flowchart illustrating a processing procedure of the processor 11 during the management processing and a processing procedure of the processor 21 associated with the management processing.

When the processor 11 in the multifunction device 10 starts the management processing, the process proceeds to ACT 11.

In ACT 11, the processor 11 determines one of the label printers 20 registered as management targets as a target printer. For example, based on the printer management data DAA, the processor 11 causes the operation and display unit 14 to display a screen showing a list of the label printers 20 registered as management targets, and determines the label printer 20 designated by the worker on the list as the target printer.

In ACT 12, the processor 11 requests the target printer to print a test image based on the test image data DAC stored in the auxiliary memory unit 13. That is, the processor 11 causes the communication unit 18 to send predetermined request data for requesting printing and the test image data DAC stored in the auxiliary memory unit 13 to the communication network 200, for example, to a communication address included in the printer management data DAA for the target printer.

When the request data is transmitted to the label printer 20, which is the target printer, via the communication network 200 and received by the communication unit 27, the processor 21 proceeds to ACT 21 in FIG. 4 in the control processing based on the control program PRB.

In ACT 21, the processor 21 prints the test image in response to the request. In this case, the print unit 26 executes thermal control based on the thermal history table TAA stored in the auxiliary memory unit 23. The test image may be determined as appropriate by, for example, a person who determines specifications of the printer management system 100, as an image including print elements that can be printed by the label printer 20, such as a plurality of lines of different thicknesses, characters, barcodes, and the like. In this way, the processor 21 executes information processing based on the control program PRB, and the computer with the processor 21 as its central part functions as a control unit.

The test image data DAC may be stored in, for example, the auxiliary memory unit 23 in each label printer 20. In this case, the processor 11 in the multifunction device 10 does not transmit the test image data DAC when a request to print a test image is made. Then, in the label printer 20, the processor 21 prints a test image based on the test image data DAC stored in the auxiliary memory unit 23 in response to a request to print a test image from the multifunction device 10.

The worker picks up the label paper sheet on which the test image is printed by the target printer from the target printer, sets the label paper sheet in the scan unit 15 of the multifunction device 10, and issues an instruction to start reading. In response to this instruction, the processor 11 proceeds to ACT 13.

In ACT 13, the processor 11 causes the scan unit 15 to read the test image printed on the set label paper sheet. In other words, the scan unit 15 is an example of a reading unit.

In ACT 14, the processor 11 detects differences between the image data obtained by the scan unit 15 in ACT 13 and the test image data DAC stored in the auxiliary memory unit 13. In other words, the image data obtained in ACT 13 represents an image based on the test image data DAC, but when thermal control in the target printer is not performed properly, the image represented by the test image data will not be printed correctly and the image data obtained in ACT 13 will differ from the test image data DAC. The processor 11 then detects the differences that arise in this way. Thus, the processor 11 executes information processing based on the control program PRA, and the computer with the processor 11 as its central part functions as a detection unit.

In ACT 15, the processor 11 checks whether a predetermined change condition is satisfied with respect to the difference detected in ACT 14. The change condition is a condition that is met when degradation beyond an acceptable range occurs in the test image printed by the target printer, and may be determined as appropriate by, for example, the person who decides the specifications of the printer management system 100. When the change condition is met, the processor 11 determines YES and proceeds to ACT 16.

In ACT 16, the processor 11 acquires the printing conditions when a test image is printed by the target printer. The printing conditions acquired here are actual printing conditions for the test image for each item of the printing conditions evaluated when determining the thermal history table TAA. That is, the processor 11 acquires, for example, the printing speed, outside temperature, humidity, head element temperature, paper type, and ribbon type. The processor 11 acquires the printing conditions, for example, by displaying a screen on the operation and display unit 14 that allows the worker to designate these conditions and inputting the conditions designated by the worker on the screen.

The processor 11 may acquire some items, such as the printing speed or the head element temperature, from the target printer via the communication network 200.

In ACT 17, the processor 11 generates a thermal history table that can compensate for the difference detected in ACT 14, taking into account the printing conditions acquired in ACT 16. For example, the processor 11 generates the thermal history table by artificial intelligence (AI) processing using the thermal history modeling data DAB. The thermal history modeling data DAB is also called thermal history modeling algorithm data. The thermal history modeling data DAB is a model that predicts the thermal history table from the printing conditions, and is optimized by machine learning of the printing results of the label printer 20 under various printing conditions. Here, the processor 11 determines a thermal history table that can compensate for the difference detected in ACT 14 by generation by AI processing. In other words, the processor 11 executes information processing based on the control program PRA, and the computer with the processor 11 as its central part functions as a determination unit.

In ACT 18, the processor 11 transmits the generated thermal history table from the communication unit 18 to the communication network 200, addressed to the target printer.

When the thermal history table is transmitted to the target printer via the communication network 200 and received by the communication unit 27 of the target printer, the processor 21 proceeds to ACT 22.

In ACT 22, the processor 21 updates the received thermal history table as a new thermal history table TAA by overwriting the thermal history table TAA already stored in the auxiliary memory unit 23 with the received thermal history table. Thus, the processor 11 sending the thermal history table to the communication unit 18 in the multifunction device 10 is an example of a process for setting the thermal history table in the label printer 20. In other words, the processor 11 executes information processing based on the control program PRA, and the computer with the processor 11 as its central part functions as a processing unit. In addition, the processor 21 executes information processing based on the control program PRB, so that the computer with the processor 21 as its central part functions as a rewriting unit.

When the change condition is not met for the difference detected in ACT 14, the processor 11 in the multifunction device 10 determines NO in ACT 15 and passes ACT 16 to ACT 18. Therefore, in this case, the thermal history table TAA of the target printer is not updated.

As described above, the printer management system 100 reads the test image actually printed by the label printer 20 based on the test image data using the scan unit 15 in the multifunction device 10. The multifunction device 10 then detects the difference between the test image read by the scan unit 15 and the test image represented by the test image data, generates a thermal history table that compensates for the difference, and transmits the thermal history table to the label printer 20. The label printer 20 updates the thermal history table TAA stored in the auxiliary memory unit 23 to the thermal history table transmitted from the multifunction device 10. In this way, the thermal history table TAA applied to the thermal control of the label printer 20 can be optimized according to the actual print conditions of the label printer 20, making it possible to perform thermal control in the label printer 20 appropriately according to the actual usage conditions.

The multifunction device 10 also acquires the printing conditions when a test image is printed by the label printer 20 and generates a thermal history table appropriate for printing under those printing conditions. As a result, the label printer 20 is able to perform thermal control using an appropriate thermal history table according to the actual usage conditions of the label printer 20, making it possible to print appropriate images under those usage conditions.

The printer management system 100 can be realized by using the scan function of the multifunction device 10 to read a test image and adding to the multifunction device 10 a function for generating a thermal history table based on the read results. It is very common for stores such as supermarkets to be equipped with multifunction devices and label printers. By introducing the multifunction device 10 and label printer 20 of the above embodiment as the multifunction device and label printer installed in the store in this way and enabling communication via the communication network 200 such as an in-store LAN, the printer management system 100 can be efficiently realized.

This embodiment can be modified in various ways as follows.

In ACT 17, the processor 11 may determine the thermal history table by selecting a thermal history table appropriate for compensating for the difference detected in ACT 14 from a plurality of thermal history tables prepared in advance.

The predetermined process for setting the thermal history table in the label printer, such as writing the thermal history table to a portable memory device that can be read by the label printer 20, may be a process separate from the transmission.

For example, the image processing apparatus of the present application may be realized as a device in a form different from the multifunction device 10, such as a printer management device that mainly performs information processing for managing the label printer 20 in the above embodiment.

For example, a type of thermal printer other than a label printer, such as a printer that prints any image on a plain paper sheet in response to a print request from another information processing device, may be set as a management target.

The process for determining the thermal history table may be executed by an information processing device, such as a cloud server, separate from the device that reads the test image.

Each function realized by the processors 11 and 21 through information processing can also be realized in part or in whole by hardware that executes information processing not based on a program, such as a logic circuit. Furthermore, each of the above functions can also be realized by combining hardware such as the above-described logic circuits with software control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Appendix 1

The image processing apparatus according to the apparatus above, wherein the determination unit uses, as the condition information, information indicating at least one of a print speed, an outside air temperature, a humidity, and a head element temperature.

### Appendix 2

A printer management system, where
a thermal printer and an image processing apparatus are configured to be able to communicate with each other via a communication network,
the thermal printer includes:
a memory unit that stores a thermal history table;
a printing unit that uses a thermal head to print an image with thermal control according to the thermal history table stored in the memory unit; and
a control unit that controls the printing unit to print an image based on predetermined test image data,
the image processing apparatus includes:
a reading unit that reads an image printed by the printing unit based on the test image data;
a detection unit that detects a difference between the image read by the reading unit and a test image represented by the test image data;
a determination unit that determines a thermal history table for compensating for the difference detected by the detection unit; and
a processing unit that performs processing to transmit the thermal history table determined by the determination unit to the thermal printer, and
the thermal printer further includes:
a rewriting unit that rewrites the thermal history table stored in the memory unit with the thermal history table transmitted from the processing unit.

### Appendix 3

A multifunction device, including:
a reading unit that reads an image printed based on predetermined test image data by a thermal printer that performs thermal control according to a thermal history table;
a detection unit that detects a difference between the image read by the reading unit and a test image represented by the test image data;
a determination unit that determines a thermal history table for compensating for the difference detected by the detection unit; and
a processing unit that performs a predetermined process for setting the thermal history table determined by the determination unit in the thermal printer.

### Appendix 4

A printer management system, where
a thermal printer and a multifunction device are configured to be able to communicate with each other via a communication network,
the thermal printer includes:
a memory unit that stores a thermal history table;
a printing unit that uses a thermal head to print an image with thermal control according to the thermal history table stored in the memory unit; and
a control unit that controls the printing unit to print an image based on predetermined test image data;
the multifunction device includes:
a reading unit that reads the image printed by the printing unit based on the test image data;
a detection unit that detects a difference between the image read by the reading unit and a test image represented by the test image data;
a determination unit that determines a thermal history table for compensating for the difference detected by the detection unit; and
a processing unit that performs processing to transmit the thermal history table determined by the determination unit to the thermal printer, and
the thermal printer further includes:
a rewriting unit that rewrites the thermal history table stored in the memory unit with the thermal history table transmitted from the processing unit.

What is claimed is:

1. An image processing apparatus, comprising:
a reading component configured to read an image printed based on predetermined test image data by a thermal printer that performs thermal control according to a thermal history table;
a detector configured to detect a difference between the image read by the reading component and a test image represented by the test image data;
a determination component configured to determine a thermal history table for compensating for the difference detected by the detector; and
a processing component configured to perform a predetermined process for setting the thermal history table determined by the determination component, in the thermal printer.

2. The image processing apparatus according to claim 1, wherein
the determination component acquires predetermined condition information regarding a printing condition for the image read by the reading component, and determines the thermal history table by taking into account the acquired condition information.

3. The image processing apparatus according to claim 2, wherein
the determination component uses, as the condition information, information indicating a type of printing paper on which the image read by the reading component is printed.

4. The image processing apparatus according to claim 3, wherein
the determination component uses, as the condition information, information indicating a type of ink ribbon used to print the image read by the reading component.

5. The image processing apparatus according to claim 1, wherein
the processing component transmits the thermal history table determined by the determination component to the thermal printer.

6. The image processing apparatus according to claim 1, wherein
the thermal history table comprises data that defines a time for energizing a heating element when forming one dot with a single heating element, a new energization status of each of a plurality of heating elements predetermined as reference elements, and a plurality of energization patterns each having a different past energization history.

7. The image processing apparatus according to claim 1, wherein
the processing component is further configured to perform thermal control of adjusting a time for energizing a heating element.

8. An information processing method executed by a computer that controls an image processing apparatus, comprising:
reading an image printed based on predetermined test image data by a thermal printer that performs thermal control according to a thermal history table;
detecting a difference between the image read and a test image represented by the test image data;
determining a thermal history table that compensates for the difference detected by the detecting; and
performing a predetermined process for setting the thermal history table determined by the determining, in the thermal printer.

9. The image processing method according to claim 8, further comprising:
acquiring predetermined condition information regarding a printing condition for the image read by the reading component, and
determining the thermal history table by taking into account the acquired condition information.

10. The image processing method according to claim 9, further comprising:
using, as the condition information, information indicating a type of printing paper on which the image read is printed.

11. The image processing method according to claim 10, further comprising:
using, as the condition information, information indicating a type of ink ribbon used to print the image read.

12. The image processing method according to claim 8, further comprising:
transmitting the thermal history table determined to the thermal printer.

13. The image processing method according to claim 8, wherein
the thermal history table comprises data that defines a time for energizing a heating element when forming one dot with a single heating element, a new energization status of each of a plurality of heating elements predetermined as reference elements, and a plurality of energization patterns each having a different past energization history.

14. The image processing method according to claim 8, further comprising:
performing thermal control by adjusting a time for energizing a heating element.

15. A printer management system, comprising:
a thermal printer and an image processing apparatus configured to communicate with each other via a communication network,
the thermal printer includes:
a memory that stores a thermal history table;
a printer that uses a thermal head to print an image with thermal control according to the thermal history table stored in the memory; and
a controller that controls the printer to print an image based on predetermined test image data,
the image processing apparatus includes:
a reader that reads an image printed by the printer based on the test image data;
a detector that detects a difference between the image read by the reader and a test image represented by the test image data;
a determination component that determines a thermal history table for compensating for the difference detected by the detector; and
a processing component that performs processing to transmit the thermal history table determined by the determination component to the thermal printer, and
the thermal printer further includes:
a rewriter that rewrites the thermal history table stored in the memory with the thermal history table transmitted from the processing component.

16. The printer management system according to claim 15, wherein
the determination component acquires predetermined condition information regarding a printing condition for the image read by the reader, and determines the thermal history table by taking into account the acquired condition information.

17. The printer management system according to claim 16, wherein
the determination component uses, as the condition information, information indicating a type of printing paper on which the image read by the reader is printed.

18. The printer management system according to claim 17, wherein
the determination component uses, as the condition information, information indicating a type of ink ribbon used to print the image read by the reader.

19. The printer management system according to claim 15, wherein
the processing component transmits the thermal history table determined by the determination component to the thermal printer.

20. The printer management system according to claim 15, wherein
the thermal history table comprises data that defines a time for energizing a heating element when forming one dot with a single heating element, a new energization status of each of a plurality of heating elements predetermined as reference elements, and a plurality of energization patterns each having a different past energization history.
